(19) United States
(12) Patent Application Publication
(10) Pub. No.: US 2010/0091188 A1
(43) Pub. Date: Apr. 15, 2010

(54) SYNCHRONIZATION OF SECONDARY DECODED MEDIA STREAMS WITH A PRIMARY MEDIA STREAM

(75) Inventors: Kausik Maiti, New Delhi (IN); Philippe Monnier, Villard Bonnot (FR); Shiv Kumar Singh, New Delhi (IN); Rahul Bansal, Delhi (IN); Nitin Jain, Meerut (IN); Bharat Jauhari, Lucknow (IN)

Correspondence Address: STMicroelectronics Inc.;c/o WOLF, GREENFIELD & SACKS, P.C., 600 Atlantic Avenue, BOSTON, MA, 02210-2206, US

(73) Assignees: STMicroelectronics Pvt. Ltd., Greater Noida, Uttar Pradesh (IN); STMicroelectronics (Grenoble) SAS, Grenoble (FR)

(21) Appl. No.: 12/500,692

(22) Filed: Jul. 10, 2009

(30) Foreign Application Priority Data
Jul. 11, 2008 (IN) 1667/DEL/2008

(51) Int. Cl. H04N 7/00; H04N 9/76; H04N 7/16; H04N 5/91

(52) U.S. Cl. 348/485; 348/598; 725/151; 386/95; 386/E05.003; 348/E07.024

(57) ABSTRACT

System and method for synchronizing one or more secondary decoded media streams to a primary decoded media stream. The system includes a media stream processor and a mixer. The media stream processor receives a primary decoded media stream and secondary decoded media streams. The media stream processor synchronizes the secondary decoded media streams with the primary decoded media stream. The output of the media stream processor is coupled to the mixer. The mixer receives its second input from the primary decoded media stream. The mixer mixes the received streams and generates a PTS value for its output media stream by extrapolating the PTS of the primary decoded media stream.

### CROSS REFERENCE TO RELATED APPLICATIONS

This application claims the priority benefit of Indian patent application number 1667/Del/2008, filed on Jul. 11, 2008, entitled “SYNCHRONIZATION OF SECONDARY DECODED MEDIA STREAMS WITH A PRIMARY MEDIA STREAM,” which is hereby incorporated by reference to the maximum extent allowable by law.

### BACKGROUND OF THE INVENTION

1. Field of the Invention

The present invention discloses a system and method for synchronization of one or more decoded media streams with a primary media stream, where the secondary media streams can be altered to delay or drop samples to effect synchronization.

2. Discussion of the Related Art

Multimedia based systems are the most common form of communication and entertainment systems in use today. The appreciation of such systems is difficult for people suffering from vision/aural impairment. To enable such people to understand the media an “audio description/video description” that provides audible description of the scene/subtitles for the deaf and hearing impaired are transmitted along with the normal audio and video signals.

An “Audio Description” channel is an auxiliary component associated with TV services which delivers a verbal description of a visual as an aid to understanding. The Audio Description channel is offered on a separate channel known as the SAP i.e. “Secondary Audio Program” channel. However, it is noted that the audio description stream is not able to keep pace with the main audio stream of a transport channel. It therefore needs to be adjusted periodically in order to maintain synchronization with the main channel.

Similarly subtitle or subpicture tracks in various languages, including those made especially for the deaf and hearing impaired are transmitted stored as bitmap images with transparent background and are shown over the video during playback.

Many systems and methods have been disclosed which keep the audio description channel in sync with the main multimedia stream. U.S. Pat. No. 5,661,665 discloses a category of systems and methods for multimedia synchronization wherein the individual media streams samples are routed through different sets of processing components. FIG. 1 describes the rendering of the samples or sink of the samples by means of a rendering component using a reference clock. A reference clock 101 generates a reference clock signal for the components of the system. A start time and stop time are specified by means of this common reference clock. A source component 103 reads a media sample chosen from a media source 102 which stores various media samples. The presentation time of the media sample is calculated and on the basis of calculated presentation time, it is determined whether the media sample should be rendered by a sink component 104. The calculated presentation time is then associated with the media sample by means of the source component 103 before it is forwarded to the sink component 104. The media components are then routed through a transfer component 105 to the sink component 104. Each media sample is then rendered by the sink component 104 at an approximate time relative to the common clock reference generated by the reference clock 101 as indicated by the presentation time associated with and attached to the media sample. When the source component 103 encounters a calculated presentation time greater than specified stop time, the source component 103 stops reading the same thereby stopping the rendering of the sample. Before the stop time, the application program sends a command for initiation of a second media sample and specifies a start time in accordance to the stop time. As the second media stream is rendered, the presentation time is modified to account for its delayed start time relative to the first media stream. Thereby the output received at the player end 106 is synchronized. In such system the synchronization is achieved by using separate synchronization modules for each media stream.

US 2004/0128702 describes another category of such systems and methods which are used for outputting a main media stream and a secondary media stream in sync with each other. FIG. 2 describes a flow diagram of the output media stream routine The main media stream is output 201. The routine then waits for an event to occur 202 wherein the event that occurs may be a trigger event or the end of the main media stream. The routine then determines whether the main media stream has ended 203. If so, the routine ends else it identifies the event to be a trigger event and determines whether each associated secondary stream is to be output synchronously or asynchronously with the main media stream 204. These secondary media streams are then iteratively output according to predefined priority 205 in the manner (synchronously/asynchronously) determined in 204. Thus, the output obtained at the player end is synchronized. The disclosure refers to synchronization of main media stream and secondary media stream based on the trigger from the main media stream.

The methods and systems as described above provide a solution to synchronize two similar kinds of media. However the systems will require the knowledge of the mixing delays at the output which can be variable and unpredictable. This can lead to wrong alignment of the main and secondary media channels and which is more important. This synchronization mechanism is not only limited to media type as PCM audio but also to can be useful for video and subtext, to BTSC encoded main audio and SAP etc.

Therefore, a system and method is required that achieves the afore-mentioned objectives.

### SUMMARY OF THE INVENTION

To achieve at least the desired objective, as well as others, one embodiment of the present disclosure describes a system comprising a media stream synchronizer for synchronizing one or more secondary decoded media streams to a primary decoded media stream, said media stream synchronizer comprising a Presentation Time Stamp (PTS) extractor for the decoded primary media stream, individual PTS extractors for each secondary media stream,

a PTS comparator for each secondary media stream, said PTS comparator receiving the output of said PTS extractor for the primary media stream and the output of the PTS extractor of its secondary media stream an output enabler for each secondary media stream, controlled by the output of its PTS comparator for providing the synchronized secondary media stream, a PTS Generator for each synchronized secondary media stream providing the final synchronized secondary media stream with corrected PTS, and a mixer combining the decoded primary media stream and all the decoded synchronized secondary media streams to produce the final output.

The present disclosure also describes a set-top box comprising a media stream synchronizer for synchronizing one or more secondary decoded media streams to a primary decoded media stream, said media stream synchronizer comprising a Presentation Time Stamp (PTS) extractor for the decoded primary media stream, individual PTS extractors for each secondary media stream, a PTS comparator for each secondary media stream, said PTS comparator receiving the output of said PTS extractor for the primary media stream and the output of the PTS extractor of its secondary media stream an output enabler for each secondary media stream, controlled by the output of its PTS comparator for providing the synchronized secondary media stream, a PTS Generator for each synchronized secondary media stream providing the final synchronized secondary media stream with corrected PTS, and a mixer combining the decoded primary media stream and all the decoded synchronized secondary media streams to produce the final output.

The present disclosure further describes a Video Cassette Recorder (VCR) comprising a media stream synchronizer for synchronizing one or more secondary decoded media streams to a primary decoded media stream, said media stream synchronizer comprising a Presentation Time Stamp (PTS) extractor for the decoded primary media stream, individual PTS extractors for each secondary media stream, a PTS comparator for each secondary media stream, said PTS comparator receiving the output of said PTS extractor for the primary media stream and the output of the PTS extractor of its secondary media stream an output enabler for each secondary media stream, controlled by the output of its PTS comparator for providing the synchronized secondary media stream, a PTS Generator for each synchronized secondary media stream providing the final synchronized secondary media stream with corrected PTS, and a mixer combining the decoded primary media stream and all the decoded synchronized secondary media streams to produce the final output.

The present disclosure further describes a media stream synchronizer for synchronizing one or more secondary decoded media streams to a primary decoded media stream, said media stream synchronizer comprising a Presentation Time Stamp (PTS) extractor for the decoded primary media stream, individual PTS extractors for each secondary media stream, a PTS comparator for each secondary media stream, said PTS comparator receiving the output of said PTS extractor for the primary media stream and the output of the PTS extractor of its secondary media stream an output enabler for each secondary media stream, controlled by the output of its PTS comparator for providing the synchronized secondary media stream, a PTS Generator for each synchronized secondary media stream providing the final synchronized secondary media stream with corrected PTS, and a mixer combining the decoded primary media stream and all the decoded synchronized secondary media streams to produce the final output.

This disclosure also teaches a method for synchronizing one or more secondary decoded media streams to a primary decoded media stream comprising extracting the Presentation Time Stamp (PTS) of the decoded primary media stream, extracting the individual PTS for each secondary media stream, comparing the PTS of each secondary media stream, with the PTS of the primary media stream, enabling each secondary media stream based on the result of said comparison, generating an updated PTS for each synchronized secondary media stream, and mixing the decoded primary media stream and all the decoded synchronized secondary media streams to produce the final output.

### BRIEF DESCRIPTION OF THE DRAWINGS

These and other features and aspects of the various embodiments of the invention will be better understood when the following detailed description is read with reference to the accompanying drawings in which like characters represent like parts throughout the drawings:

FIG. 1 illustrates a system for multimedia synchronization according to a conventional art.

FIG. 2 illustrates a synchronization mechanism for multimedia captioning and audio description according to a conventional art.

FIG. 3 illustrates a system for synchronizing one or more secondary decoded media streams to a primary decoded media stream according to an embodiment of the present invention.

FIG. 4 describes a media processor of a system for synchronizing one or more secondary decoded media streams to a primary decoded media stream according to an embodiment of the invention.

FIG. 5 illustrates a schematic representation of a method for synchronizing one or more secondary decoded media streams to a primary decoded media stream according to an embodiment of the invention.

FIG. 6 illustrates flow diagram of a method of producing updated secondary media streams according to an embodiment of the present invention.

FIG. 7 illustrates an exemplary embodiment of a method for producing updated secondary media decoded streams according to the present invention.

### DETAILED DESCRIPTION

The embodiments of the present invention will be described in detail with reference to the accompanying drawings. However, the present invention is not limited to these embodiments. The present invention can be modified in various forms. The embodiments of the present invention described herein are only provided to explain more clearly the present invention to the ordinarily skilled in the art. In the accompanying drawings, like reference numerals are used to indicate like components.

The term PTS(n) meaning the n^{th} input of a secondary decoded media stream has been used interchangeably with PTS(i) i.e. input of the stream and PTS, and the term PTS(M) is taken to be same as term PTS_{M}, where M denotes the master input

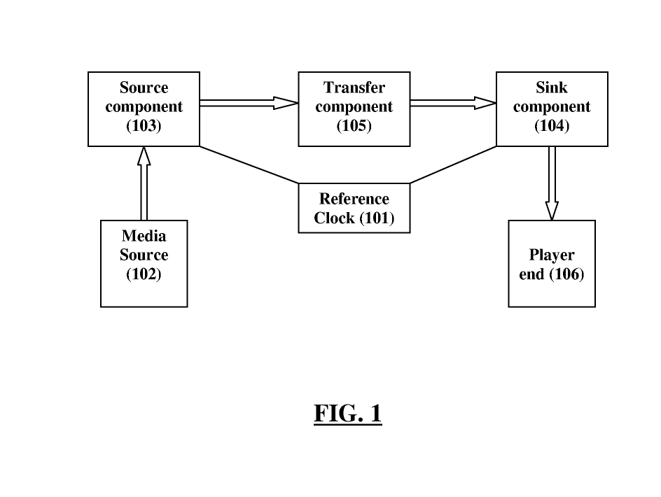

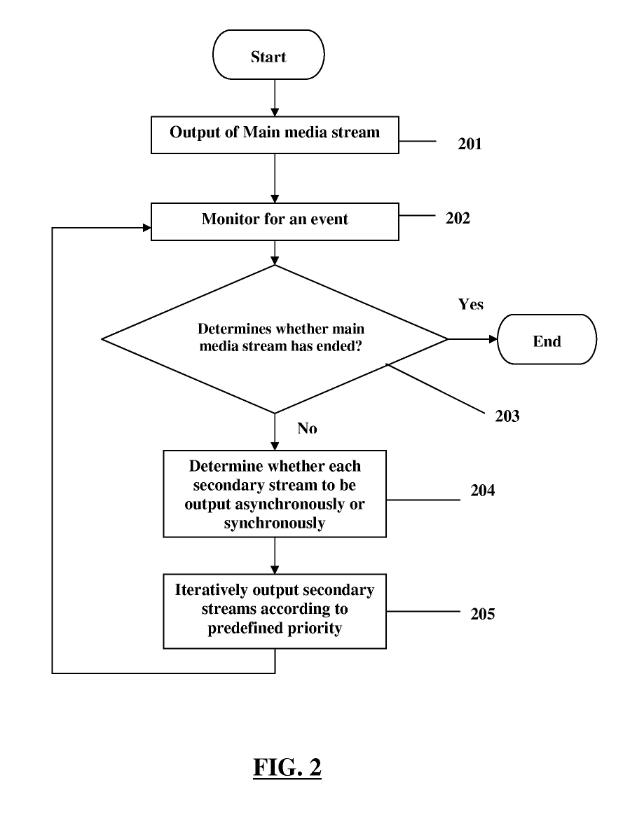

FIG. 1 and FIG. 2 disclosing the conventional methods have been described in the “Background” section.

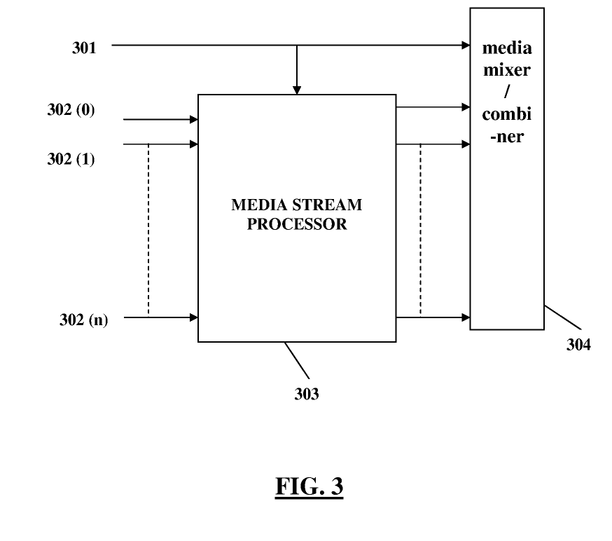

FIG. 3 describes a system for synchronizing one or more secondary decoded media streams to a primary decoded media stream according to an embodiment of the present invention. The transport channel comprises of a primary media stream and secondary media streams. In a system for television based services, these media streams are decoded by using one or more decoding techniques such as PCM. The embodiment disclosed comprises a media stream processor 304 receiving a primary decoded media stream 301 and secondary decoded media streams 302(0), 302(1), 302(2), . . . 302(n). The media stream processor 303 synchronizes the secondary decoded media streams 302 with the primary decoded media stream 301. The output of said media stream processor 303 is coupled to a media combiner/mixer 304, which also receives at its input the primary decoded media stream 301. The media combiner/mixer 304 generates a PTS value for the produced output media stream by extrapolating the PTS of the primary decoded media stream 301.

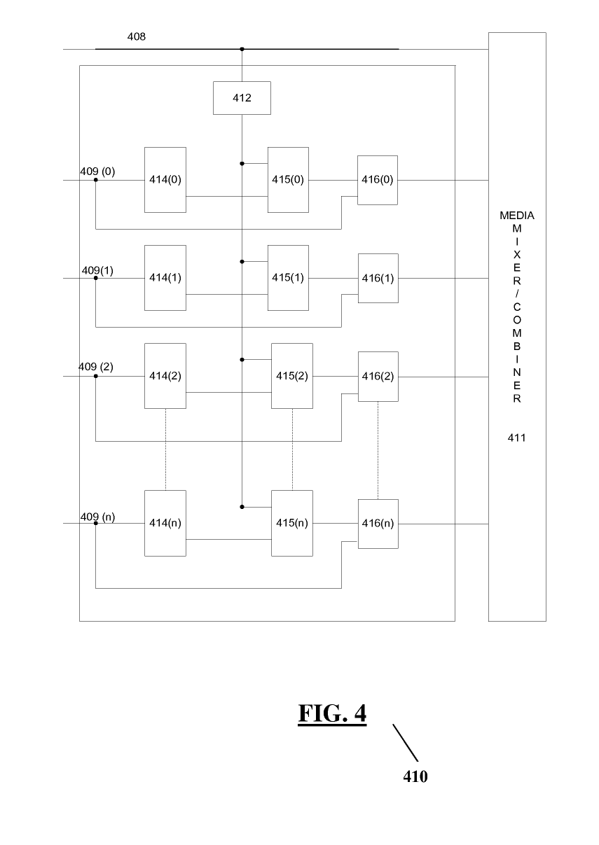

FIG. 4 describes a media stream processor 410 according to an embodiment of the invention which comprises a Presentation Time Stamp (PTS) extractor 412 to extract the PTS value of a primary decoded media stream 408. Media stream processor 410 having a processing channel for each secondary decoded media stream receives the extracted PTS value of the primary decoded media stream at one input. Each channel of the media stream processor 410 comprises a PTS extractor 414 to extract the PTS value of the secondary decoded media stream 409 connected to its input. The extracted PTS value of the secondary channel is coupled to one input of a PTS comparator 415. The second input of the comparator 415 receives the PTS value of the primary decoded media stream 408. The comparator 415 compares the PTS value of the primary decoded media stream with the PTS value of the secondary decoded media stream and drives the control input of an output enabling unit 416, which receives the secondary decoded media stream at its input. The gated output forms the output of said media stream processor 410. The comparator 415 controls the output enabling unit 416 by means of predefined criterion which updates the secondary decoded media stream such that the output at the gating unit 416 is synchronized with the primary decoded media stream. The output of said media stream processor 410 is coupled to a media combiner/mixer 411 which generates a PTS value for the produced output media stream by extrapolating the PTS of the primary stream 408.

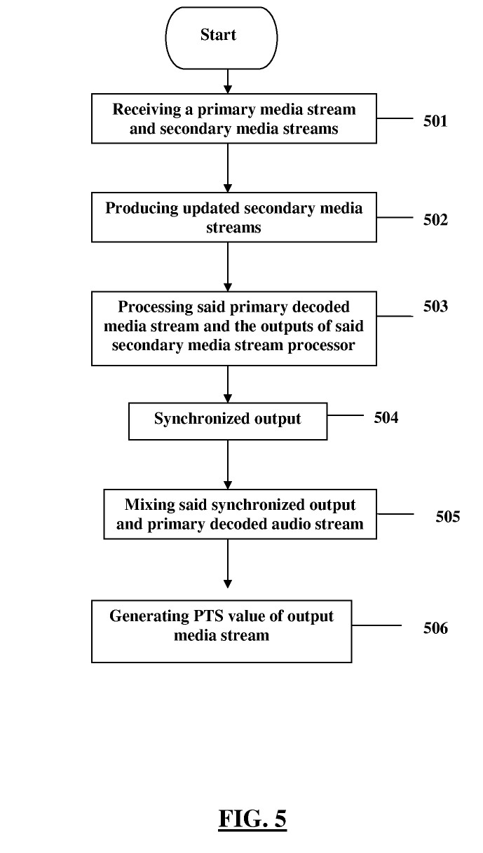

The methods as described in FIGS. 5, 6 and 7 are illustrated as a collection of blocks in a logical flow graph, which represents a sequence of operations that can be implemented in hardware, software, or a combination thereof. The order in which the process is described is not intended to be construed as a limitation, and any number of the described blocks can be combined in any order to implement the process, or an alternate process.

FIG. 5 refers to a schematic representation of a method for synchronizing one or more secondary decoded media streams to a primary decoded media stream according to an embodiment of the invention. The media stream processor receives primary decoded media streams and secondary decoded media streams 501 and produces updated secondary decoded media streams 502. These updated secondary decoded media streams are synchronized with the primary decoded media stream by means of said media stream processor. The updated secondary decoded media streams are then coupled to the input of a media combiner/mixer which processes said updated secondary decoded media streams and said primary decoded media stream 503 received at its other input. The primary and secondary decoded media are combined/mixed by the media combiner/mixer 505. The media combiner/mixer generates a PTS value for its output media stream by extrapolating the PTS value of said primary decoded media stream 506.

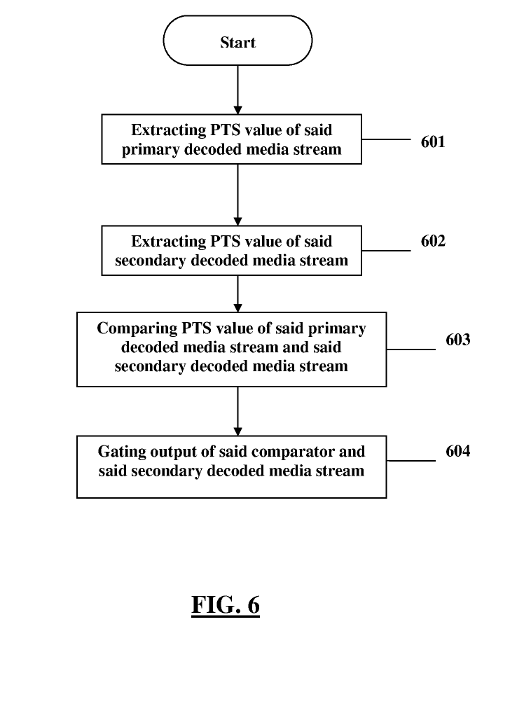

FIG. 6 illustrates a flow diagram of a method of producing updated secondary decoded media streams according to an embodiment of the invention. The Presentation Time Stamp (PTS) of the primary decoded media stream is extracted 601 by means of a PTS extractor 412. Processing of the secondary decoded media streams 602 is enabled by employing a processing channel for each secondary decoded media stream. Processing by each processing channel comprises of extracting the PTS value of the secondary decoded media stream 603 by means of a PTS extractor 414. The PTS value of the secondary decoded media stream is further compared to the PTS value of the primary decoded media stream 604 by means of a PTS comparator. The output of the comparator and the primary decoded media stream is gated 605 to an output enabling unit, which is controlled by said comparator on basis of a predefined criterion. The comparator thus updates the secondary decoded media stream and hence, synchronizes the secondary decoded media streams with the primary media decoded stream. The output of said media processor is then coupled to input of the media combiner/mixer which further produces an output in accordance to steps 505 and 506 of FIG. 5.

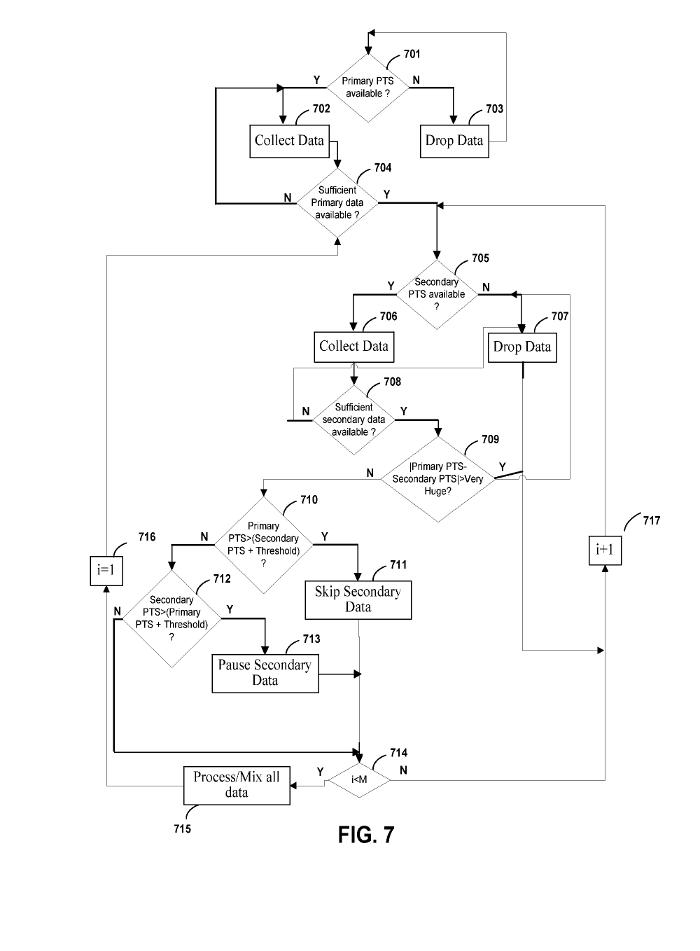

FIG. 7 illustrates an exemplary embodiment of a method for updating secondary decoded media streams according to the present invention. At step 701, the availability of a primary PTS is checked. At step 702, the data are collected when the primary PTS is available. At step 703, the data are dropped when the primary PTS is not available. At step 704, the availability of sufficient primary data is checked. If the sufficient primary data is not available, additional data are collected by repeating the step 702. At step 705, the availability of a secondary PTS is checked when the sufficient primary data are collected. At step 706, the data are collected when the secondary PTS is available. At step 707, the data is dropped when the secondary PTS is not available. At step 708, the availability of a sufficient secondary data is checked. If the sufficient secondary data is not available, all collected data is dropped in step 707. At step 709, the absolute difference between the primary PTS and secondary PTS very large and no operation can be done on the data then all data is dropped at step 707. At step 710, the primary PTS greater than the sum of secondary PTS and threshold value is checked. At step 711, the secondary data are skipped when the primary PTS is greater than the sum of secondary PTS and threshold value. At step 712, the secondary PTS greater than the sum of primary PTS and threshold value is checked. At step 713, the secondary data are paused when the secondary PTS is greater than the sum of primary PTS and threshold value. At step 714, the input no “i” less than the maximum available secondary inputs “M”. At step 717, the value of the input “i” is incremented by “1” to select the (i+1)^{th} secondary input for processing At step 715 the primary and all the secondary media is processed/Mixed and PTS extrapolated. At step 716, the secondary input “i” is set to 0. and the process again begins from step 704.

The number of samples required i.e. the sufficient data from a particular input is

Nᵢ=┌Tₒᵤₜ*Fᵢ┐

Where, Tₒᵤₜ=Output Frame Duration (Sec)

Fᵢ=Input Sampling Frequency of i^{th} Input (Hz)

Sufficient data ensures the proper processing and synchronization of the media streams.

The mathematical representation of conditions used in above steps is:
1 . . . . |PTSᵢ−PTS_{M}| very huge: drop i^{th} interface data
2 . . . . PTSᵢ>(PTS_{M}+THRESHOLD); Pause (PTSᵢ−PTS_{M}) data from i^{th} interface
3 . . . . PTS_{M}>(PTSᵢ+THRESHOLD); Skip for (PTS_{M}−PTSᵢ) from i^{th} interface
4 . . . . Otherwise main and description channel are in sync

THRESHOLD is the allowable limit of the PTS difference which will not cause any observable synchronization problem. Ideally, the value of THRESHOLD must be as small as possible.

On the basis of the comparison, the output of the gating unit skips some amount of data, then that data is assumed to have been consumed. The obtained sufficient data is then sent for processing in the mixer after dropping. The data sent is calculated on basis of the following:—

$$\begin{matrix}Data sent = {T}_{out} or data available after skipping \\ = 0 ; if no data available after skipping\end{matrix}$$

If the data is required to be paused, the system shall output data on the basis of the following:

Data sent on i^{th} input =(Tₒᵤₜ − Pause_duration)*Fᵢ ; if
Tₒᵤₜ > Pause_duration

= 0; if Tₒᵤₜ <= Pause_duration

The PTS value on the secondary decoded media stream is then extrapolated 757 linearly. After, the synchronization and mixing has been achieved on said decoded media streams, PTS(M) is incremented as per the produced samples i.e.

PTS_{M}=PTS_{M}+(Tₒᵤₜ/(90*1000)); PTS is in 90 KHz ticks

If the primary decoded media stream has an PTS associated with the first sample then PTS_{M} is updated to that value with similar updates being done on the secondary decoded media streams as well.

Thus, after mixing the output of the mixer has a single PTS associated with it and since the secondary decoded media streams are aligned within the accepted threshold of the primary decoded media stream, they are in sync.

As a further application, a presentation module will synchronize the mixed media output with a video stream of the channel in TV services wherein according to said application Fading value (FADE) is applied on the primary decoded media stream to ensure standard signal levels on the secondary decoded media streams. Panning value (PAN) is applied to place the “describer” at any preferred horizontal within the sound field. For stereo the PAN value is restricted to ±30° of the center front.

The application of FADE and PAN values are as encoded in the stream. But in the absence of the values due to corruption or loss of signal, they need to ramp up to the default value (0x00) and maintain a smooth restoration of the values from (0x00) wherein the ramp up/down should be over a period of at least 1 sec.

The ramp up/down will be done in steps as follows
1 . . . . The rate of change=(Vᵢₙᵢₜᵢₐₗ−V_{final}) per sec
2 . . . . The step size will be Sₙ=(Vᵢₙᵢₜᵢₐₗ−V_{final})/T_{D}; Where T_{D} is the interval of application of the value

But if the system gets valid values even before reaching the default values value when the valid value of the parameter is received is determined Vᵢₙᵢₜᵢₐₗ=Vᵢₙᵢₜᵢₐₗ+Sₙ*n; where n is the number of steps already being incremented.

With this new initial value as the base value and we repeat afore mentioned steps 1 and 2. But if the final value is changing within 1 sec then the following steps are taken:—
Nₛ=1/T_{D}; Number of steps required to reach the desired value in 1 sec.
n=number of steps already taken
V_{cur}=Current value of the value to be applied after n steps

The step size on receipt of a new valid parameter is calculated as below with the assumption that a 1 sec window is applied:

S′ₙ(V_{new}−V_{cur})/Nₛ−n);

where
V_{new}: new initial value calculated as the base value;
V_{cur}: Current value of the value to be applied after n steps
Nₛ: Number of steps required to reach the desired value in 1 sec.
n: the number of steps being incremented.

The disclosure shows and describes embodiments of the invention; however the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention as disclosed herein. Also, it is intended that the appended claims be construed to include alternative embodiments.

What is claimed is:

1. A system comprising a media stream synchronizer for synchronizing one or more secondary decoded media streams to a primary decoded media stream, said media stream synchronizer comprising:
a Presentation Time Stamp (PTS) extractor for the decoded primary media stream,
individual PTS extractors for each secondary media stream,
a PTS comparator for each secondary media stream, said PTS comparator receiving the output of said PTS extractor for the primary media stream and the output of the PTS extractor of its secondary media stream;
an output enabler for each secondary media stream, controlled by the output of its PTS comparator for providing the synchronized secondary media stream corrected PTS; and
a mixer combining the decoded primary media stream and all the decoded synchronized secondary media streams to produce the final output.

2. The system as claimed in claim 1, wherein said PTS comparator comprises an evaluator that generates an enable output whenever the absolute difference between the PTS value of the decoded primary media stream and the PTS value of the decoded secondary media stream is less than or equal to a defined threshold value.

3. The system as claimed in claim 1, wherein said PTS comparator comprises an evaluator that generates a disable output whenever the absolute difference between the PTS value of the decoded primary media stream and the PTS value of the decoded secondary media stream is greater than a defined limiting value.

4. The system as claimed in claim 1, wherein said PTS comparator comprises an evaluator that generates a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.

5. The system as claimed in claim 1, wherein said PTS comparator comprises an evaluator that generates a disable output for a duration equal to the difference between the PTS value of the decoded primary media stream and the PTS value of the decoded secondary media stream whenever the PTS value of the decoded primary media stream is greater than the PTS value of the decoded secondary media stream by a value less than a defined threshold value.

6. A set-top box comprising a media stream synchronizer for synchronizing one or more secondary decoded media streams to a primary decoded media stream, said media stream synchronizer comprising:
a Presentation Time Stamp (PTS) extractor for the decoded primary media stream,
individual PTS extractors for each secondary media stream,
a PTS comparator for each secondary media stream, said PTS comparator receiving the output of said PTS extractor for the primary media stream and the output of the PTS extractor of its secondary media stream;
an output enabler for each secondary media stream, controlled by the output of its PTS comparator for providing the synchronized secondary media stream with corrected PTS; and
a mixer combining the decoded primary media stream and all the decoded synchronized secondary media streams to produce the final output.

7. The set-top box as claimed in claim 6, wherein said PTS comparator comprises an evaluator that generates an enable output whenever the absolute difference between the PTS value of the decoded primary media stream and the PTS value of the decoded secondary media stream is less than or equal to a defined threshold value.

8. The set-top box as claimed in claim 6, wherein said PTS comparator comprises an evaluator that generates a disable output whenever the absolute difference between the PTS value of the decoded primary media stream and the PTS value of the decoded secondary media stream is greater than a defined limiting value.

9. The set-top box as claimed in claim 6, wherein said PTS comparator comprises an evaluator that generates a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.

10. The set-top box as claimed in claim 6, wherein said PTS comparator comprises an evaluator that generates a disable output for a duration equal to the difference between the PTS value of the decoded primary media stream and the PTS value of the decoded secondary media stream whenever the PTS value of the decoded primary media stream is greater than the PTS value of the decoded secondary media stream by a value less than a defined threshold value.

11. A Video Cassette Recorder comprising a media stream synchronizer for synchronizing one or more secondary decoded media streams to a primary decoded media stream, said media stream synchronizer comprising:
a Presentation Time Stamp (PTS) extractor for the decoded primary media stream,
individual PTS extractors for each secondary media stream,
a PTS comparator for each secondary media stream, said PTS comparator receiving the output of said PTS extractor for the primary media stream and the output of the PTS extractor of its secondary media stream;
an output enabler for each secondary media stream, controlled by the output of its PTS comparator for providing the synchronized secondary media stream with corrected PTS; and
a mixer combining the decoded primary media stream and all the decoded synchronized secondary media streams to produce the final output.

12. The Video Cassette Recorder as claimed in claim 11, wherein said PTS comparator comprises an evaluator that generates an enable output whenever the absolute difference between the PTS value of the decoded primary media stream and the PTS value of the decoded secondary media stream is less than or equal to a defined threshold value.

13. The Video Cassette Recorder as claimed in claim 11, wherein said PTS comparator comprises an evaluator that generates a disable output whenever the absolute difference between the PTS value of the decoded primary media stream and the PTS value of the decoded secondary media stream is greater than a defined limiting value.

14. The Video Cassette Recorder as claimed in claim 11, wherein said PTS comparator comprises an evaluator that generates a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.

15. The Video Cassette Recorder as claimed in claim 11, wherein said PTS comparator comprises an evaluator that generates a disable output for a duration equal to the difference between the PTS value of the decoded primary media stream and the PTS value of the decoded secondary media stream whenever the PTS value of the decoded primary media stream is greater than the PTS value of the decoded secondary media stream by a value less than a defined threshold value.

16. A media synchronizer for synchronizing one or more secondary decoded media streams to a primary decoded media stream, said media stream synchronizer comprising:
a Presentation Time Stamp (PTS) extractor for the decoded primary media stream,
individual PTS extractors for each secondary media stream,
a PTS comparator for each secondary media stream, said PTS comparator receiving the output of said PTS extractor for the primary media stream and the output of the PTS extractor of its secondary media stream;
an output enabler for each secondary media stream, controlled by the output of its PTS comparator for providing the synchronized secondary media stream with corrected PTS; and
a mixer combining the decoded primary media stream and all the decoded synchronized secondary media streams to produce the final output.

17. The media synchronizer as claimed in claim 16, wherein said PTS comparator comprises an evaluator that generates an enable output whenever the absolute difference between the PTS value of the decoded primary media stream and the PTS value of the decoded secondary media stream is less than or equal to a defined threshold value.

18. The media synchronizer as claimed in claim 16, wherein said PTS comparator comprises an evaluator that generates a disable output whenever the absolute difference between the PTS value of the decoded primary media stream and the PTS value of the decoded secondary media stream is greater than a defined limiting value.

19. The media synchronizer as claimed in claim 16, wherein said PTS comparator comprises an evaluator that generates a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.

20. The media synchronizer as claimed in claim 16, wherein said PTS comparator comprises an evaluator that generates a disable output for a duration equal to the difference between the PTS value of the decoded primary media stream and the PTS value of the decoded secondary media stream whenever the PTS value of the decoded primary media stream is greater than the PTS value of the decoded secondary media stream by a value less than a defined threshold value.

21. A method for synchronizing one or more secondary decoded media streams to a primary decoded media stream comprising;
extracting a Presentation Time Stamp (PTS) of the decoded primary media stream,
extracting an individual PTS for each secondary media stream,
comparing the PTS of each secondary media stream, with the PTS of the primary media stream;
enabling each secondary media stream based on the result of said comparison;
generating an updated PTS for each synchronized secondary media stream; and
mixing the decoded primary media stream and all the decoded synchronized secondary media streams to produce the final output.

22. The method as claimed in claim 21 wherein the enabling comprises generating an enable output whenever the absolute difference between the PTS value of the decoded primary media stream and the PTS value of the decoded secondary media stream is less than or equal to a defined threshold value

23. The method as claimed in claim 21 wherein the enabling comprises generating a disable output whenever the absolute difference between the PTS value of the decoded primary media stream and the PTS value of the decoded secondary media stream is greater than a defined limiting value.

24. The method as claimed in claim 21 wherein the enabling comprises generating a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.

25. The method as claimed in claim 21 wherein the enabling comprises generating a disable output for a duration equal to the difference between the PTS value of the decoded primary media stream and the PTS value of the decoded secondary media stream whenever the PTS value of the decoded primary media stream is greater than the PTS value of the decoded secondary media stream by a value less than a defined threshold value.

26. A Mobile platform comprising a media stream synchronizer for synchronizing one or more secondary decoded media streams to a primary decoded media stream, said media stream synchronizer comprising:
a Presentation Time Stamp (PTS) extractor for the decoded primary media stream,
individual PTS extractors for each secondary media stream,
a PTS comparator for each secondary media stream, said PTS comparator receiving the output of said PTS extractor for the primary media stream and the output of the PTS extractor of its secondary media stream;
an output enabler for each secondary media stream, controlled by the output of its PTS comparator for providing the synchronized secondary media stream with corrected PTS; and
a mixer combining the decoded primary media stream and all the decoded synchronized secondary media streams to produce the final output.

27. The mobile platform as claimed in claim 26, wherein said PTS comparator comprises an evaluator that generates an enable output whenever the absolute difference between the PTS value of the decoded primary media stream and the PTS value of the decoded secondary media stream is less than or equal to a defined threshold value.

28. The mobile platform as claimed in claim 26, wherein said PTS comparator comprises an evaluator that generates a disable output whenever the absolute difference between the PTS value of the decoded primary media stream and the PTS value of the decoded secondary media stream is greater than a defined limiting value.

29. The mobile platform as claimed in claim 26, wherein said PTS comparator comprises an evaluator that generates a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.

30. A platform supporting BTSC with SAP comprising a media stream synchronizer for synchronizing one or more secondary decoded media streams to a primary decoded media stream, said media stream synchronizer comprising:
a Presentation Time Stamp (PTS) extractor for the decoded primary media stream,
individual PTS extractors for each secondary media stream,
a PTS comparator for each secondary media stream, said PTS comparator receiving the output of said PTS extractor for the primary media stream and the output of the PTS extractor of its secondary media stream;
an output enabler for each secondary media stream, controlled by the output of its PTS comparator for providing the synchronized secondary media stream with corrected PTS; and
a mixer combining the decoded primary media stream and all the decoded synchronized secondary media streams to produce the final output.

31. The platform supporting BTSC with SAP as claimed in claim 30, wherein said PTS comparator comprises an evaluator that generates an enable output whenever the absolute difference between the PTS value of the decoded primary media stream and the PTS value of the decoded secondary media stream is less than or equal to a defined threshold value.

32. The platform supporting BTSC with SAP as claimed in claim 30, wherein said PTS comparator comprises an evaluator that generates a disable output whenever the absolute difference between the PTS value of the decoded primary media stream and the PTS value of the decoded secondary media stream is greater than a defined limiting value.

33. The platform supporting BTSC with SAP as claimed in claim 26, wherein said PTS comparator comprises an evaluator that generates a disable output for a duration equal to the difference between the PTS value of the decoded secondary media stream and the PTS value of the decoded primary media stream whenever the PTS value of the decoded secondary media stream is greater than the PTS value of the decoded primary media stream by a value less than a defined threshold value.
